(19) United States
(12) Patent Application Publication
(10) Pub. No.: US 2006/0171752 A1
(43) Pub. Date: Aug. 3, 2006

(54) Apparatus for generating print data from a selected image of a video stream and method therefor

(76) Inventors: Akihiro Tanaka, Osaka-shi (JP); Toshiya Mori, Settsu-shi (JP); Hideki Kagemoto, Nara-shi (JP); Koichiro Yamaguchi, Takatsuki-shi (JP); Yoshihisa Terada, Kamagaya-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/546,688

(22) PCT Filed: Jan. 27, 2005
(86) PCT No.: PCT/JP05/01544

§ 371 Date: Aug. 23, 2005

(30) Foreign Application Priority Data
Jan. 28, 2004 (JP) 2004-020439

(51) Int. Cl. B41J 5/30

(52) U.S. Cl. 400/62

(57) ABSTRACT

A receiving unit (101) of a print data generating apparatus (100), which enables a printing that reflects user's preferences even in a digital broadcasting environment, receives and modulates digital broadcast waves. A video/data separating unit (102) separates a signal received from the receiving unit (101) into a video packet, an audio packet and a data packet that includes print information. A print information storing unit (104) is a RAM for storing print information, or the like, and reads the print information from the data packet received from the video/data separating unit (102), and stores it. A print information converting unit (108) reads the print information stored in the print information storing unit (104) and image data stored in an image storing unit (106), updates the print information by inserting, into the print information, image information representing the image data, based on the read-out print information and image data, and transmits the updated print information to a print information notifying unit (109). The print information notifying unit (109) transmits the received print information to a printing apparatus (120).

### TECHNICAL FIELD

The present invention relates to a print data generating apparatus that generates print data by use of videos obtained via digital broadcasting, and also to a content creating apparatus that creates a content that includes videos obtained via an external memory.

### BACKGROUND ART

Under the provision of satellite digital broadcasting, data broadcasting for transmitting data such as text data is currently distributed independently from a main broadcasting for transmitting video and audio data. The data transmitted via data broadcasting is received and analyzed by a receiving terminal, and then presented to the user via a private browser and a display apparatus.

Recently, making use of the fact that information exclusively used for printing (hereinafter to be referred to as “print information”) is provided via data broadcasting, printing based on the interpretation of print information on the side of a receiving terminal is suggested (see reference, for example, to Japanese Laid-Open Application No. 2002-158979). The technique of printing a scene in a video selected by the user has also been suggested (see reference; for example, to Japanese Laid-Open Application No. 2002-232815).

Similarly, in the digital terrestrial broadcasting that has entered an operation phase for a while, it is also suggested that the user is allowed to print a data content distributed via data broadcasting, so as to obtain the information including images in printed form. Based on this, when the data content that is linked to a TV program and is distributed via data broadcasting is printed, it is desirable that the related images should be printed together.

At present, the suggested methods allow the user to copy a scene taken from the TV program using a video printer or to print only the print information obtained via data broadcasting. The user, however, cannot print as he/she likes because layout is previously determined for printing the data content obtained via digital broadcasting.

The present invention is conceived in view of the above problem, and an object of the present Invention is to provide a print data generating apparatus which enables a printing that reflects user's preferences.

### DISCLOSURE OF INVENTION

In order to achieve the above object, the print data generating apparatus according to the present invention generates print data based on a content included in digital broadcasting, and includes: a broadcast wave receiving unit operable to receive digital broadcast waves, and to separate a video stream from the digital broadcast waves; an image specifying unit operable to specify, according to a selecting instruction from a user, an image in a video displayed based on the separated video stream; a print information obtaining unit operable to obtain print information described in a format that allows an insertion of an image into an object to be printed; an insertion place specifying unit operable to specify a place in the obtained print information for inserting information representing the specified image; and a print information converting unit operable to insert the information representing the specified image into the specified place, and to generate print data.

Thus, it is possible to insert information related to an image taken from a broadcast program into the print information received via data broadcasting and generate print data.

When inserting the information representing the specified image; the print information converting unit may impose a limitation on at least one of: a time when the selecting instruction is received; and a number of selected images.

Note that the present invention can be realized as the print data generation method that includes, as steps, the characteristic units included in the print data generating apparatus or as a program that causes a personal computer to execute such steps. It is for sure that the program can be widely distributed via a storage medium such as a DVD or a transmission medium such as the Internet.

As described above, with the use of the print data generating apparatus or the print data generation method according to the present invention, it is possible to print based on the received print information so that the images specified by the user can be inserted.

### FURTHER INFORMATION ABOUT TECHNICAL BACKGROUND TO THIS APPLICATION

The disclosure of Japanese Patent Application No. 2004-020439 filed on Jan. 28, 2004, including specification, drawings and claims is incorporated herein by reference in its entirety.

### BRIEF DESCRIPTION OF DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing the functional structure of the print data generating apparatus according to a first embodiment;

FIG. 2 shows an example of the print information that is transmitted via digital broadcasting;

FIG. 3 shows a concrete example of the image data file to be stored into an image storing unit;

FIG. 4 is a flowchart showing the operations executed by the print data generating apparatus according to the first embodiment, from the reception of a user's selection on images and a print instruction until the execution of printing after inserting the image information into the print information;

FIG. 5 is a flowchart showing the “image inserting processing” in FIG. 4 described above;

FIG. 6 shows an example of the print information into which image information is inserted;

FIG. 7 shows an example of the printing obtained based on the print information into which the image information is inserted, according to a first embodiment;

FIG. 8A is an illustration for explaining how the user creates a content by extracting parts of a video and editing the extracted parts;

FIG. 8B shows an example of control information that is equivalent to the print information according to the first embodiment;

FIG. 9 is a block diagram showing the functional structure of the print data generating apparatus according to a second embodiment;

FIG. 10 shows an example of the print information according to the second embodiment;

FIG. 11 shows a concrete example of the image data file to be stored in the image storing unit;

FIG. 12 precisely shows the positions indicated as “first” and “last” for inserting images;

FIG. 13A shows an example of the screen for setting so that the positions for inserting images can be changed later;

FIG. 13B shows how the position for inserting an image is actually changed;

FIG. 14 is a flowchart showing a flow of the “image inserting processing” operated by the print information converting unit according to the second embodiment;

FIG. 15 shows a concrete example of the case where a line for inserting an image into a position specified by the user;

FIG. 16 is a concrete example of the object to be printed according to the second embodiment;

FIG. 17 is a block diagram showing the functional structure of the print data generating apparatus according to a third embodiment;

FIG. 18 shows an example of the print information according to the third embodiment;

FIG. 19 shows an example of the image data according to the third embodiment;

FIG. 20 shows an example of the screen for the user to change pixel values for each Image size;

FIG. 21 is a flowchart showing a flow of the “image inserting processing” according to the third embodiment;

FIG. 22 shows an example of the case where each image with the size indicated in FIG. 19 is inserted into the print information shown in FIG. 18;

FIG. 23 shows a concrete example of the object to be printed according to the third embodiment;

FIG. 24 is a block diagram showing the functional structure of the print data generating apparatus according to a fourth embodiment;

FIG. 25 shows an example of the print information according to the fourth embodiment;

FIG. 26 shows an example of the image information according to the fourth embodiment;

FIG. 27 shows an example of the print information according to a fifth embodiment;

FIG. 28 is a flowchart showing a flow of the “image inserting processing” according to the fifth embodiment; and

FIG. 29 shows an example of the print information in which the image information according to the fifth embodiment is inserted.

### BEST MODE FOR CARRYING OUT THE INVENTION

The following describes in detail the embodiments of the present invention with reference to the attached diagrams.

### First Embodiment

The print data generating apparatus according to the present embodiment is an apparatus which receives digital broadcast waves that include main broadcasting and data broadcasting, and allows the user to insert a scene (or a cut) taken from the video that is being broadcasted as a main broadcasting, into print information which is used for executing printing and is included in the data broadcasting. The scene to be inserted shall be one or more.

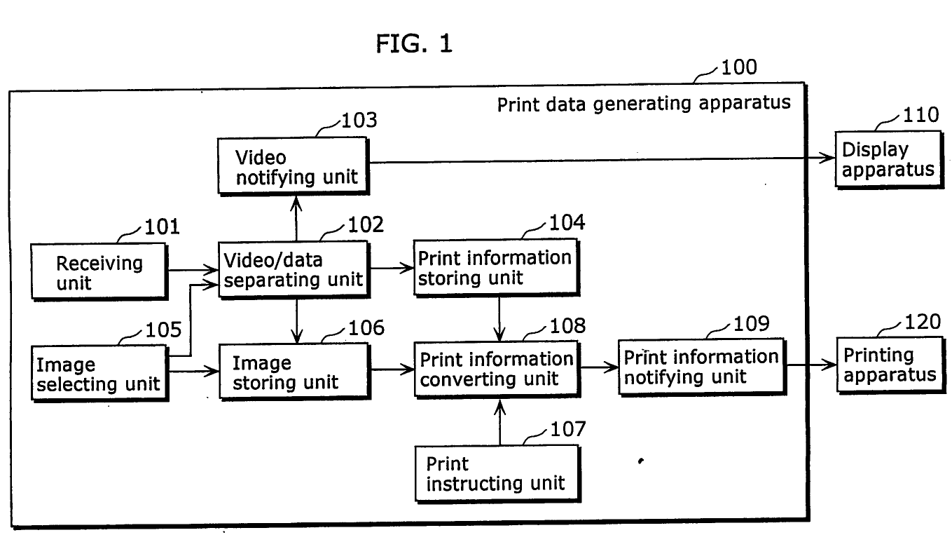

FIG. 1 is a block diagram showing the functional structure of the print data generating apparatus 100 according to the present embodiment. The print data generating apparatus 100 is comprised of a receiving unit 101, a video/data separating unit 102, a video notifying unit 103, a print information storing unit 104, an image selecting unit 105, an image storing unit 106, a print instructing unit 107, a print information converting unit 108, and a print information notifying unit 109. Note that the print data generating apparatus 100 is connected to a display apparatus 110 such as a liquid crystal display and a printer 120 such as a color inkjet printer.

The receiving unit 101 receives the digital broadcast waves that include a data broadcasting (the print information is included therein) and a main broadcasting, modulates the waves (the modulation includes necessary conditional access processing), and transmits the modulated signal (e.g., a transport stream (TS)) to the video/data separating unit 102. Note that various formats are conceivable for the print information to be transmitted via data broadcasting, but the format used in the present embodiment is the one that complies with extensible Hyper Text Markup Language-Print (XHTML-Print), and the print information includes trimming information such as Cascading Style Sheets (CSS). Note that the receiving unit 101 is an example of a broadcast wave receiving unit.

The video/data separating unit 102 separates the signal, such as a TS, received via the receiving unit 101 into a video packet, an audio packet, and a data packet that includes print information. The video packet and the audio packet thus separated are transmitted to the video notifying unit 103 while the data packet is transmitted to the print information storing unit 104, respectively. Note that the video/data separating unit 102 is an example of an image specifying unit.

The video notifying unit 103, having received the video packet from the video/data separating unit 102, transmits the video packet and others to the external display apparatus 110. In the case of digital broadcasting, a video packet or the like is normally decoded first, and then is transferred to the display apparatus 110. This process, however, is not a feature of the present invention so that the detailed description is omitted. The receiving apparatus, such as a Set Top Box (STB) that is adapted for data broadcasting, usually has a function to make a layout for the data content to be displayed as data broadcasting and transmit it to the display apparatus 110. This function, however, does not directly relate to the present invention, therefore, the description related to the layout function will be omitted.

The print information storing unit 104 is a unit having a RAM, an HDD, a removable storagedisk, or the like, for storing print information, receives the data packet from the video/data separating unit 102, reads the print information from the data packet, and stores it into the RAM. Note that the print information storing unit 104 is an example of a print information obtaining unit.

The image selecting unit 105 is, for instance, a remote controller, and has a function to receive the scene selected by the user who desires to insert it into an object to be printed. In this case, the image selecting unit 105, having received an instruction related to the selection of the scene from the user (hereinafter to be referred to as “image-selecting instruction”), transmits the image-selecting instruction to the video/data separating unit 102 and the image storing unit 106.

The image storing unit 106 is, for instance, a RAM, an HDD, or the like, for storing images. Such image storing unit 106 receives, from the video/data separating unit 102, the image for which an image-selecting instruction has just been received from the image selecting unit 105, and then, stores it as image data. The image storing unit 106 can further store a certain sequence of video as video data, not limited to shot images. The format of the image data or the video data, in this case, shall be JPEG which is one of the conceivable formats among JPEG, PNG, GIF and MPEG. When receiving an image-selecting instruction from the image selecting unit 105, the image storing unit 106 stores the image data, and also, records, in association with the image data, the time at which the image is stored. Note that the image storing unit 106 is an example of a video storing unit.

The print instructing unit 107 is, for example, a remote controller, and receives a user's instruction for printing (hereinafter to be referred to as “print instruction”) and notifies the print information converting unit 108 of the received print instruction. Note that the print instructing unit 107 is an example of an image position receiving unit or an image size receiving unit.

The print information converting unit 108, having received the notification of the print instruction from the print instructing unit 107, reads the print information stored in the print information storing unit 104 and the image data stored in the image storing unit 106, specifies the place in the print information for inserting information representing the image data (hereinafter to be referred to as “image information”), updates the print information by inserting the image information, and transmits the updated print information to the print information notifying unit 109. Note that the print information converting unit 108 is an example of an insertion place specifying unit.

The print information notifying unit 109, having received the updated print information from the print information converting unit 108, transmits the received print information to the printing apparatus 120 that is externally placed (note that the external printing apparatus 120 executes printing based on the received print information).

The following further describes the present embodiment by showing a concrete example.

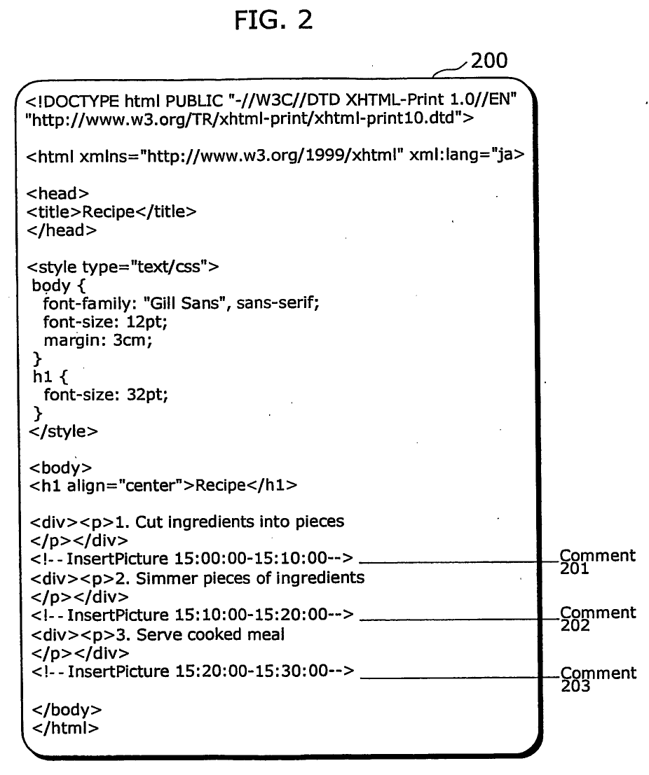

FIG. 2 shows an example of the print information which is transmitted via digital broadcast waves and stored by the print Information storing unit 104. The print information 200 in XHTML-Print format shown in FIG. 2 is an example of the print information related to a cooking recipe, that is, the information transmitted as a part of the data broadcasting corresponding to the main broadcasting for distributing a cooking program. The print information 200 is written in compliance with a grammar defined by World Wide Web Consortium (W3C). Moreover, the print information 200 is information being a part of the data packet resulted from the division of data performed by the video/data separating unit 102, and is to be stored in the RAM or the like, that is set in the print information storing unit 104.

In the present embodiment, an example of updating the print information by inserting, into the print information 200, a file name of the image data file (herein after to be referred to as “image file name”) of the image (e.g., a frame of image) selected by the user, by using a comment (or a location of a line where a comment is described) which is already described in the print information 200. Note that tags may be newly defined in order to insert images instead of using comments as described above.

As shown in FIG. 2, the comments 201 to 203 are the comments for Inserting image file names. A character string “InsertPicture” is defined at the beginning of each comment followed by a space and the definition of information indicating a range of time (absolute time) (e.g., in the case of comment 201, the range of time is defined as “15:00:00-15:10:00”). Note that, instead of using the information that indicates absolute time, as described above, Normal Play Time (NPT), or information that indicates a relative time counted based on the head of the program or a information that indicates relative time based on a specified base point in time may be used. Here, the “NPT” is information that indicates a relative time displayed during the program via data broadcasting, and is defined in ARIB STD-B24 and ARIB TR-B15.

The detailed processing of inserting image file names will be explained later.

While the cooking program is provided, the images in the program are displayed on the display apparatus 110 while the print information continues to be stored by the print information storing unit 104. When a scene which the user desires to insert as a reference image of the recipe, such that shows how to cut vegetables or how to serve the cooked meal, is displayed, the user selects an image via the image selecting unit 105 (e.g., a remote controller) while watching the program. In such case, the user may be informed that the image is recommended as a reference image for the recipe, by displaying a phrase such as “image is loadable” by flashing the message at the lower right on the screen.

The image storing unit 106, having received, from the user, the instruction for selecting an image via the image selecting unit 105, converts the scene selected from the TV program into, for example, a JPEG image data file, and stores it into the built-in RAM or HDD. In such case, the image storing unit 106 also stores, in association with the image data file, time information indicating the time when the user's instruction is received.

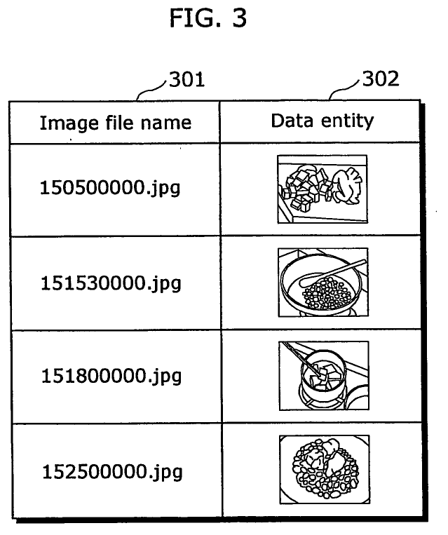

FIG. 3 shows a concrete example of the Image data file to be stored in the image storing unit 106. As shown in FIG. 3, the time selected by the user is used as a part of the image file name 301 in the present embodiment. For example, “150500000.jpg” represents a file name for the image selected precisely at 15:05:00 (15 h 05 m 00 s) by the user while “151800000.jpg” represents a file name for the image selected precisely at 15:18:00 (15 h 18 m 00 s). Note that the data entity 302 shown in FIG. 3 is the image data corresponding to the image file name mentioned in the example above (the data entity 302 in FIG. 3 presents an image of the picture), that is, binary data obtained by converting a scene taken from the video into a JPEG file.

Note that not only the time information as described above, but also the information indicating the date on which the user selected the image may be added to the image data file, if necessary. Note also that the time information may be stored as different attribute information in association with an image file name, instead of being represented as an image file name.

The print information converting unit 108, having received the print instruction from the user via the print instructing unit 107 (e.g., a remote controller), reads the print information and the image data respectively stored then in the print information storing unit 104 and the image storing unit 106, and executes processing of inserting image information into the print information (hereinafter to be referred to as “image inserting processing”). The “image inserting processing” is processing of inserting, into the print information, the image information of the image stored in the image storing unit 106 (hereinafter to be referred to as “image information”).

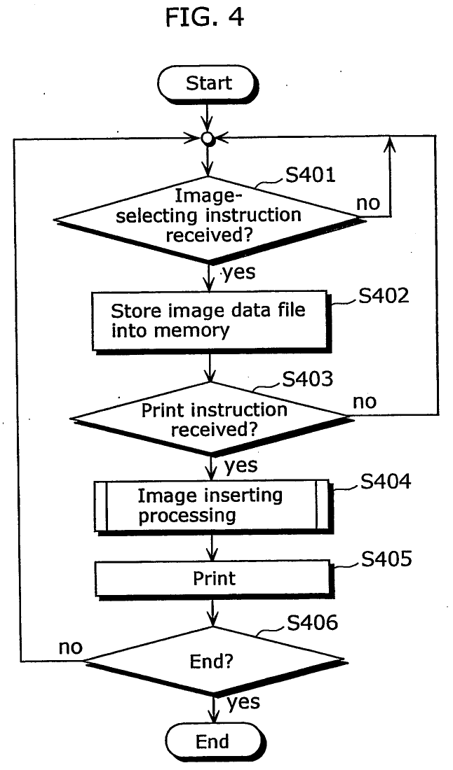

The following describes the operation performed by the print data generating apparatus 100 that has the structure described above. FIG. 4 is a flowchart showing the flow of the processing from the reception of an instruction for selecting an image as well as a print instruction, from the user, until the execution of printing processing after the insertion of image information into print information.

Firstly, the image selecting unit 105, having received from the user the instruction for selecting an image (S401: yes), notifies the video/data separating unit 102 and the image storing unit 106 of it. Then, the image storing unit 106 stores, into the built-in RAM or the like, the image data of the image, which is selected from among the video data separated by the video/data separating unit 102 and corresponds to the time at which the selecting instruction is received, together with the image file name and the time information that presents the time at which the image is selected (S402).

After that, the print instructing unit 107, having received the print instruction from the user (S403: yes), notifies the print Information converting unit 108 of it. Then, the print information converting unit 108 executes the “image inserting processing” (S404), inserts the image information into the print information, and transmits it to the printing apparatus 120. Then, the printing apparatus 120 executes printing based on the received print Information (S405).

As described above, the print data generating apparatus 100 inserts the image information of the image selected by the user into a line located just before the comment that is already defined in the print information so as to update the print information, and executes printing based on the updated print information (S401 to S406).

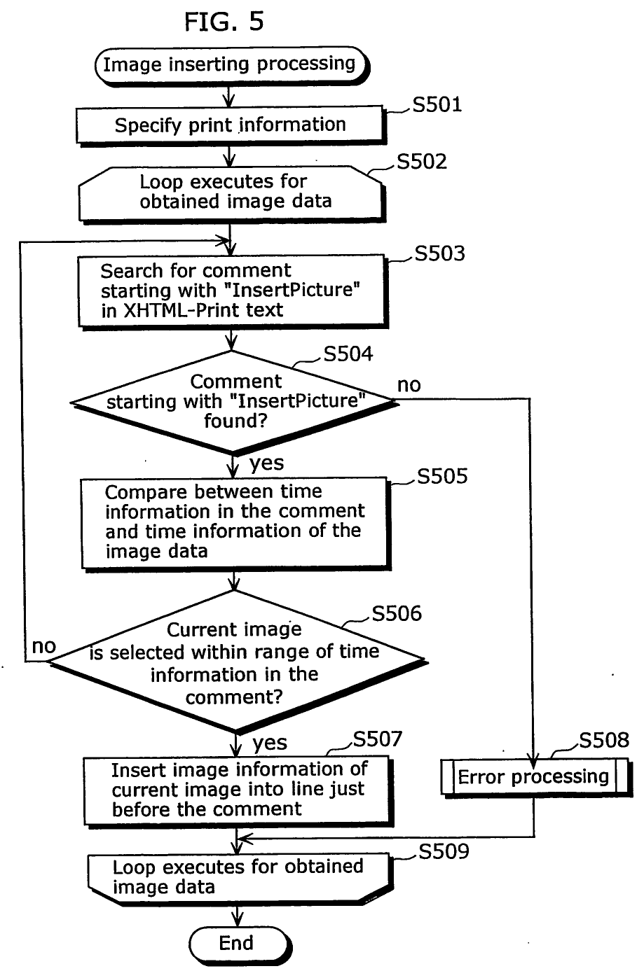

FIG. 5 is a flowchart showing the flow of the “image inserting processing” (S404) shown in FIG. 4.

Firstly, the print information converting unit 108 specifies a piece of print information stored in the print information storing unit 104, based on the print instruction received from the user (e.g., when “printing of cooking recipe” is selected just before the end of the cooking program) (S501), and repeats the following loop for the image data file stored in the image storing unit 106 (S502 to S509).

The print information converting unit 108 firstly refers to the specified print information, and searches the comment that starts with “InsertPicture” (S503). In the case where such comment is found (S504: yes), the print information converting unit 108 compares between the time information described in the comment and the time information for image data of a current image to be inserted (hereinafter to be referred to as “current image”) (S505), and examines whether or not the time information of the image data is within the time range described in the comment (S506).

In the case where the time information of the image data is included within the time range described in the comment (S506: yes), the print information converting unit 108 inserts, into the line located just before the comment, a line describing a file name of the image data file (S507). In the case where the time information for the image data is not included in the time range described in the comment (S506: no), the above processing is repeated (S503 to S506).

In the case where the comment that satisfies the above condition is not found (S504: no), error processing is executed (S508). Various processing is conceivable for the error processing in this case: notifying the user that the image could not be inserted by outputting a display of “the Image selected at such and such time could not be inserted”, or the like; and inserting image information in the end of the print information.

Note that a concrete method of inserting a current image will be explained later.

When the above processing (S502 to S509) is completed for all the obtained image data, the “image inserting processing” is terminated.

After the “image inserting processing” (S404), that is, after the completion of the update of the print information, the print information converting unit 108 transmits the updated print information and the image data to the print information notifying unit 109. The print information notifying unit 109 then transmits the print information to the external printing apparatus 120.

It should be noted that various methods are available for transmitting the print information to the external printing apparatus 120. For example, they are: a method in which the print information notifying unit 109 transfers, to the external printing apparatus 120, rasterized data into which image data is inserted by parsing print information; a method in which the print information notifying unit 109 transfers to the external printing unit 120 the received print information and image data, as files; and a method in which the print information notifying unit 109 transfers, to the external printing apparatus 120, the received print information and image data after putting them in multipart forms so as to convert them into a form of module that is used for data broadcasting. The method of passing the print information to the external printing apparatus 120, however, is not a feature of the present invention, therefore, the description is omitted.

Here, the “image inserting processing” (S404) is described by showing a concrete example. The following explains the case where the user desires to print a recipe with pictures while watching a cooking program on the TV, and sends a print instruction after having selected four scenes which are respectively taken at 15:05:00, 15:15:30, 15:18:00, and 15:25:00 as indicated in the image file names shown in FIG. 3.

The print information converting unit 108, having received, via the print instructing unit 107, the notification that the print instruction is received from the user, obtains the print information 200 shown in FIG. 2 and the image data files shown in FIG. 3, from the print information storing unit 104 and the image storing unit 106, respectively. Note that the information presenting the time when the user selected each image should be attached together with each image file name 301 to the respective image data file.

After having specified the image with the file name “150500000.jpg” as a current image, the print information converting unit 108 firstly refers to the print information 200 so as to select the comment 201 shown in the FIG. 2 as a comment which includes the time of the current Image selected by the user. Since “15:00:00-15:10:00” is described as time information in the comment 201, and the time when the specified image is selected is “15:05:00”, the print information converting unit 108 judges that the selected time is included within the range of the time described in the comment 201 (S506: yes). The print information converting unit then 108 executes the processing of inserting the specified image data file into the line just before the comment 201 (S507). More precisely, the line “<img src=”./150500000.jpg>” is inserted. “150500000.jpg” is a file name of the current image data file to be inserted.

The print information converting unit 108 further specifies, as a current image, the image data file with file name “151530000.jpg” which is stored in the image storing unit 106 as the image subsequently selected. Then, the comment 201 is selected as in the processing described above, however, the selection time “15:15:30” at which the current image is selected is not included within the time information described in the comment 201. The following comment 202 is therefore selected (S504). Since the time information “15:10:00-15:20:00” described in the comment 202 includes the time at which the current image is selected (S506: yes), the print information converting unit 108 inserts the image information of the current image in the line located just before the comment line (S507). After that, the same processing is performed for the two remaining images stored In the image storing unit 106 (S503-S508).

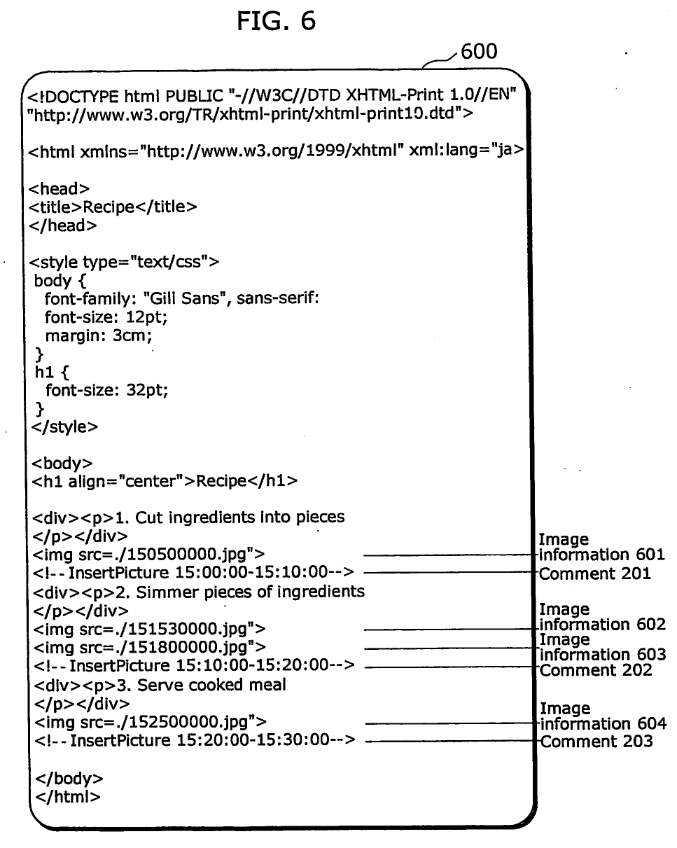

The print information into which the respective image information is inserted after the above processing is as shown in FIG. 6. The print information 600 is the print information transmitted via broadcast waves obtained as a result of newly inserting four lines as image information 601 602, 603, and 604, respectively.

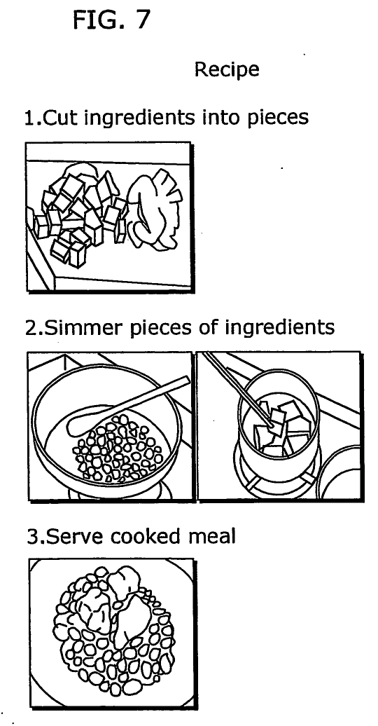

FIG. 7 shows an example in the case where the printing apparatus 110 prints based on the print information that is updated as described above. As shown in FIG. 7, by using the print data generating apparatus according to the present embodiment, it is possible to print the recipe with the four images which are selected by the user and inserted together with the cooking procedure, and thus, to generate an object to be printed that reflects user's preferences.

Note that the first embodiment describes the case where the print data generating apparatus receives, via digital broadcast waves, print information into which image information can be inserted, and executes printing after the insertion of the images selected by the user. However, the present invention is not necessarily limited to the case where printing is a purpose or the case where digital broadcast waves are used. The scenes taken from a video recorded in the external memory such as a small memory card or a Digital Versatile Disk (DVD), or the scenes stored in a storage medium such as an HDD (i.e., plural pictures) that is built in the apparatus, for instance, may be extracted for generating a content which reflects user's preferences, using the same method as described above.

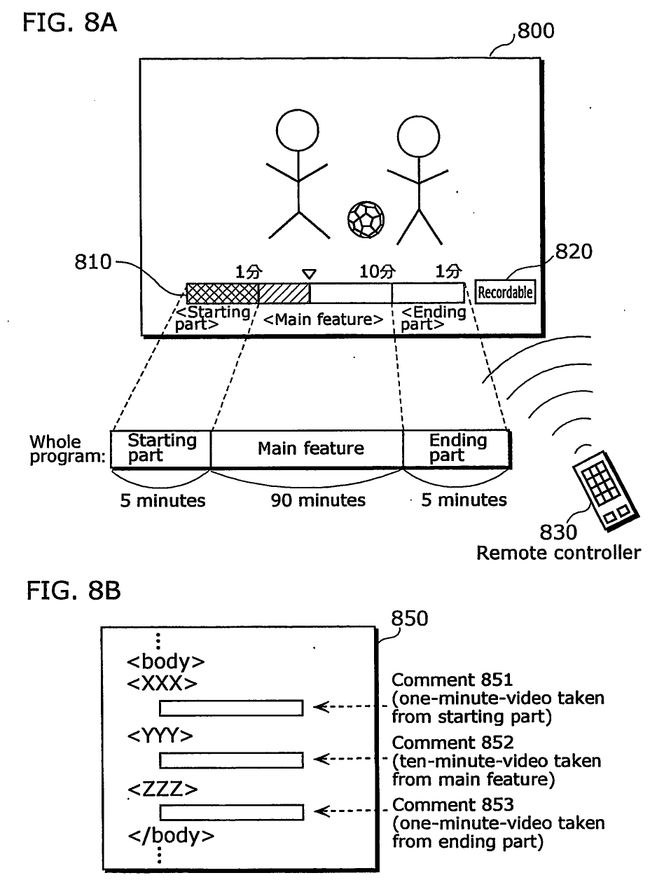

FIG. 8 shows an example of generating a content that reflects user's preferences by extracting the scenes recorded in the external memory. FIG. 8A shows how the user creates a content by extracting a part of the video for editing. In this case, the user already knows that a recording of one minute out of five minutes of starting part, a recording of ten minutes out of ninety minutes of main feature, and a recording of one minute out of five minutes of ending part are permitted as indicated by the sign “recordable” 820 on the screen 800. The user therefore can create a content composed of favorite scenes while looking at the display bar 810 on the screen 800. FIG. 8B shows an example of control information 850, an equivalent of the print information described in the first embodiment. The user can thus create a content based on the control information 850 into which the scenes selected by the user are incorporated as comments 851, 852 and 853 respectively.

### Second Embodiment

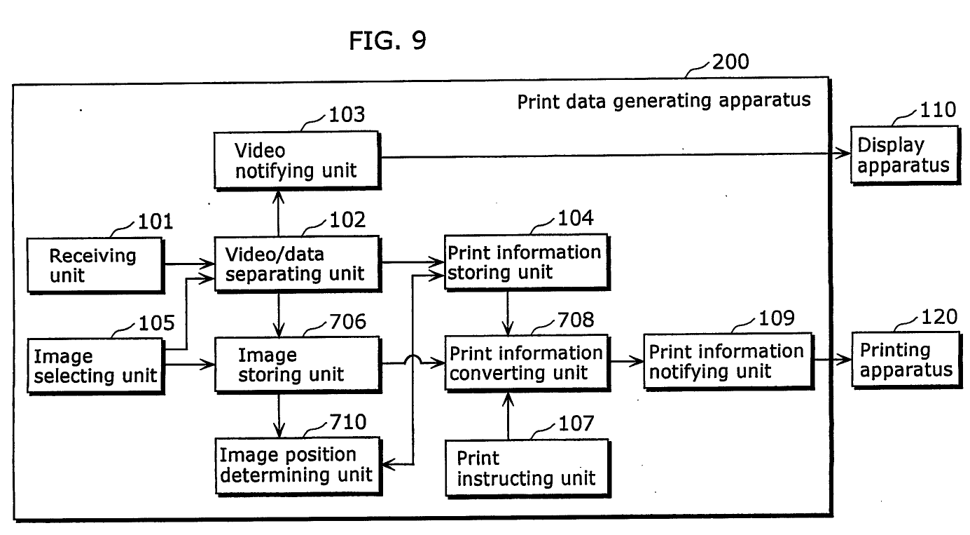

FIG. 9 is a block diagram showing the functional structure of the print data generating apparatus according to the second embodiment. The print data generating apparatus 200 according to the present embodiment differs from the print data generating apparatus 100 according to the first embodiment in that an image position determining unit 710 is added. In addition, the image storing unit 706 and the print information converting unit 708 in the present print data generating apparatus 200 function differently from the image storing unit 106 and the print information converting unit 108 in the print data generating apparatus 100 (this is why different numbers are used for reference). The same numbers are put for other components included in the present print data generating apparatus 200 as those in the print data generating apparatus 100. The description therefore is omitted.

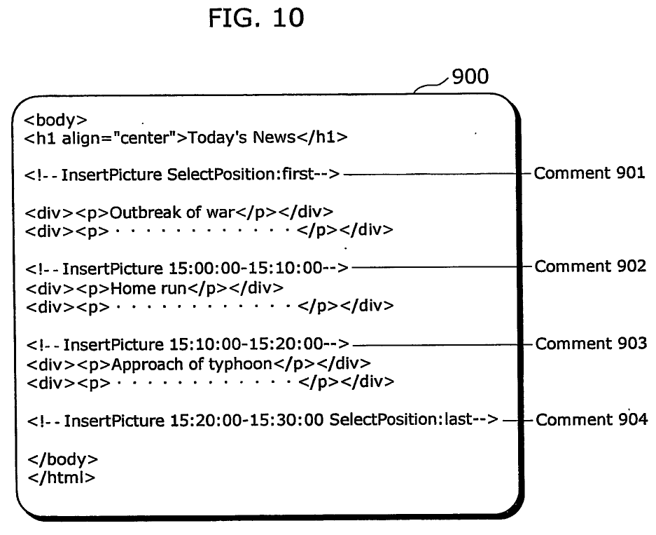

The following focuses on the difference between the present embodiment and the first embodiment. FIG. 10 shows an example of the print information transmitted via digital broadcast waves. The print information 900 according to the present embodiment shall be also a text in XHTML-Print format (also referred to as “XHTML-Print text”). Note that the trimming information such as CSS and the header information are as same as those described in the first embodiment. The description of such information is therefore omitted.

As shown in FIG. 10, the comments for inserting image information are already described in the print information 900, as is the case of the print information 200. The difference, however, is that the print information 900 includes the comments 901 and 904 that describe “SelectPosition” which will be described later.

The present embodiment differs from the first embodiment in that the user can specify the position on the print sheet for inserting the scene selected by the user.

When receiving, via a remote controller, an image-selecting instruction from the user who watches a TV program, the image selecting unit 105 notifies the video/data separating unit 102 of the reception. The image selecting unit 105, having received the notification, notifies the image storing unit 706 of the time (or date) when the instruction is received.

The image storing unit 706, having received the notification of time from the image selecting unit 105, receives (or obtains) the scene taken at the above time from the video/data separating unit 102, and converts it into JPEG formatted file as well as inquires the image position determining unit 710 of the position into which the image should be inserted.

The image position determining unit 710, having received the inquiry from the image storing unit 706, reads the print information stored in the print information storing unit 104, and searches for the comment which starts with “InsertPicture” and includes a character string “SelectPosition”. In the case of the print information 900 shown in FIG. 10, the comments 901 and 904 are the comments that satisfy the above conditions.

The image position determining unit 710 reads the description of the character string “first” or “last” that follows the character string “SelectPosition”, and inquires the user of the positions for inserting the selected scenes. Here, the images may be inserted automatically without using the indications “first” and “last”. In the case of automatic insertion, the positions of images are determined based on the time when each scene is selected (e.g., sequentially from the top in order of time at which each of the images is selected, and on the right side).

When one of “first”, “last” and “automatic” is selected by the user via the print instructing unit 107, the image position determining unit 710 notifies the image storing unit 706 of the selection. The image storing unit 706 stores a JPEG file of the current image, and at the same time, stores the position information notified by the image position determining unit 710.

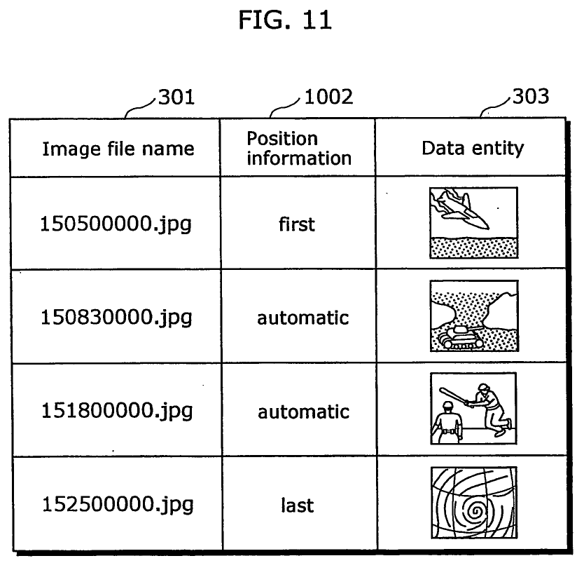

FIG. 11 shows an example of the image data that includes the position information 1002 to be stored in the image storing unit 706. As shown in FIG. 11, the scene selected at the time “15:05:00” is inserted in the position “first” while the scene selected at the time “15:25:00” is inserted in the position “last”. The example also shows the case where the scenes selected respectively at the time “15:08:30” and “15:18:00” are specified to be inserted after determining the positions by selecting “automatic”.

After that, when printing is instructed by the user, the print instructing unit 107 notifies the print information converting unit 708 of the instruction.

The following describes, with reference to a concrete example, the difference between the processing performed by the print information converting unit 708 according to the present embodiment and the one performed by the print information converting unit 108 according to the first embodiment. The print information converting unit 708 according to the present embodiment determines an image to be inserted and its position according to the print information 900 and the image-selecting instruction from the user.

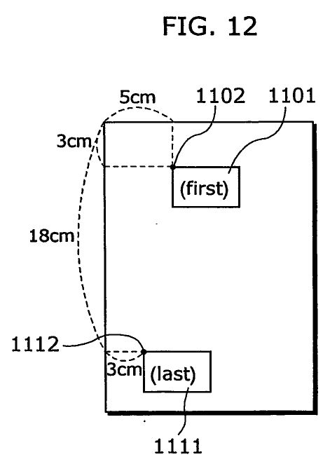

Note that the positions indicated by options (e.g., “first” and “last”) may be set beforehand (i.e. positions in a print sheet obtained as a result of printing) for the positions for inserting images. FIG. 12 is a concrete example of the positions corresponding respectively to the positions indicated by the “first” and “last” which are previously set. As shown in FIG. 12, a reference position 1102 for the position 1101 indicated as “first” is a position located at 5 cm rightward and 3 cm downward from the upper left end of the sheet. Similarly, a reference position 1112 for the position 1111 indicated as “last” is a position located at 3 cm rightward and 18 cm downward from the upper left end.

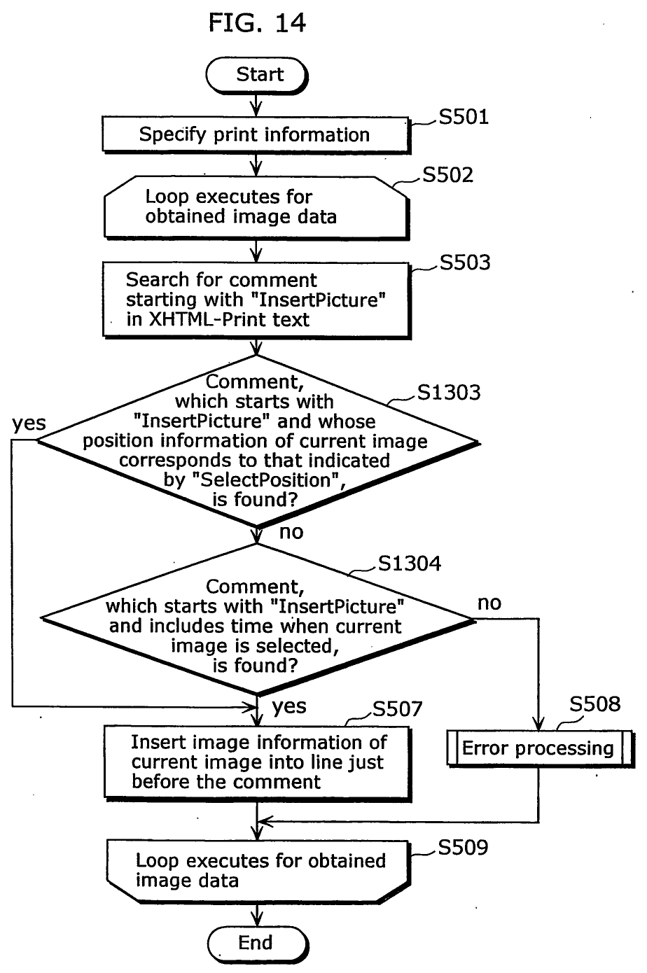

FIG. 14 is a flowchart showing the flow of the “image inserting processing” performed by the print information converting unit 708 of the present embodiment. The difference between the present flowchart and the flowchart shown in FIG. 5 described in the first embodiment lies in the processing executed in Steps S1303 and S1304.

The print information converting unit 708 searches for a comment which starts with “InsertPicture” and whose position information corresponds to that of the current image (S1303). Here, the position information is the position information 1002 shown in FIG. 11.

In the case where the comment that meets the conditions is found (S1303: yes), the processing proceeds to Step S507. In the case where such comment is not found (S1303: no), a comment, which starts with “InsertPicture” and includes the time at which the current picture is selected, is searched for (S1304). In the case where such comment is found (S1304: yes), the processing proceeds to Step S507, but in the case where such comment is not found (S1304: no), error processing is executed (S508).

In this way, by the execution of “image inserting processing” performed by the print information converting unit 708, the print information can be updated by inserting the scenes selected by the user into the positions selected by the user. The print information thus generated is then transmitted to the external printing apparatus 120 via the print information notifying unit 109, as is the case described in the first embodiment. Note that in the case where the user specifies plural images to be printed in the respective positions of “first” and “last”, the images may be placed in the positions respectively, or limitation may be imposed so that only one image is selected for the respective positions.

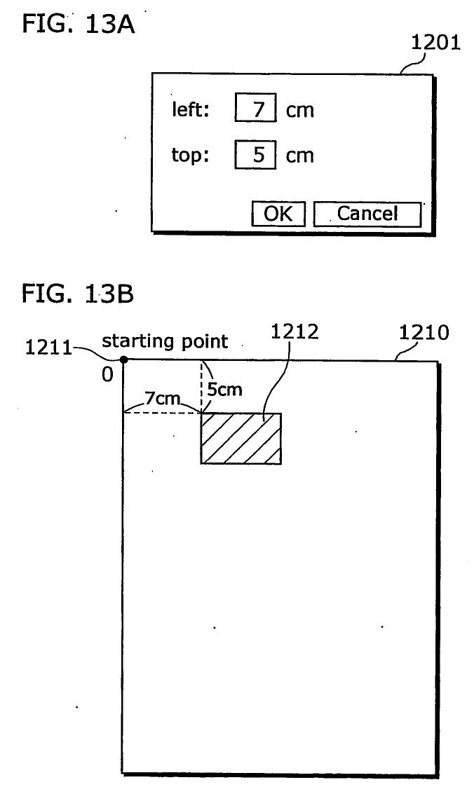

Note that, in the example shown in the present embodiment, the position for inserting an image is determined by the user who selects from among the options presented. The user, however, may indicate an exact position represented by coordinates via the print instructing unit 107, or may point at a position on a print preview screen. In such case, the user may directly specify the coordinates when an image is inserted by the print information converting unit 708. FIG. 13A shows an example of the screen for receiving, from the user, an input for setting a position for inserting an image while FIG. 13B shows how the position is changed after the user's input.

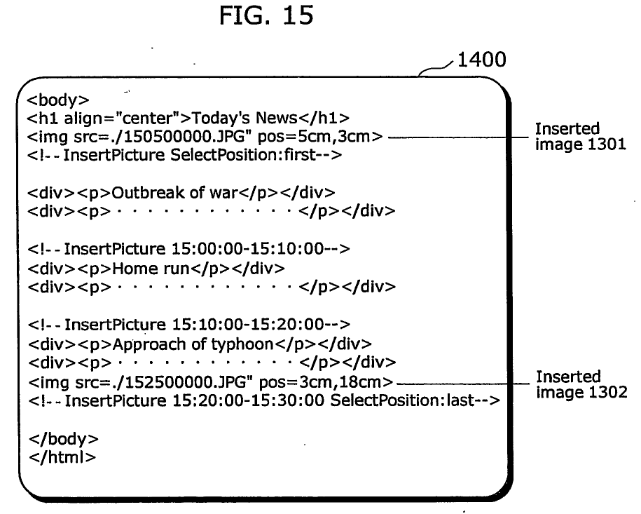

FIG. 15 shows a concrete example of the print information 1400 in the case of inserting actual image file names in the positions indicated as “first” and “last” shown in FIG. 12.

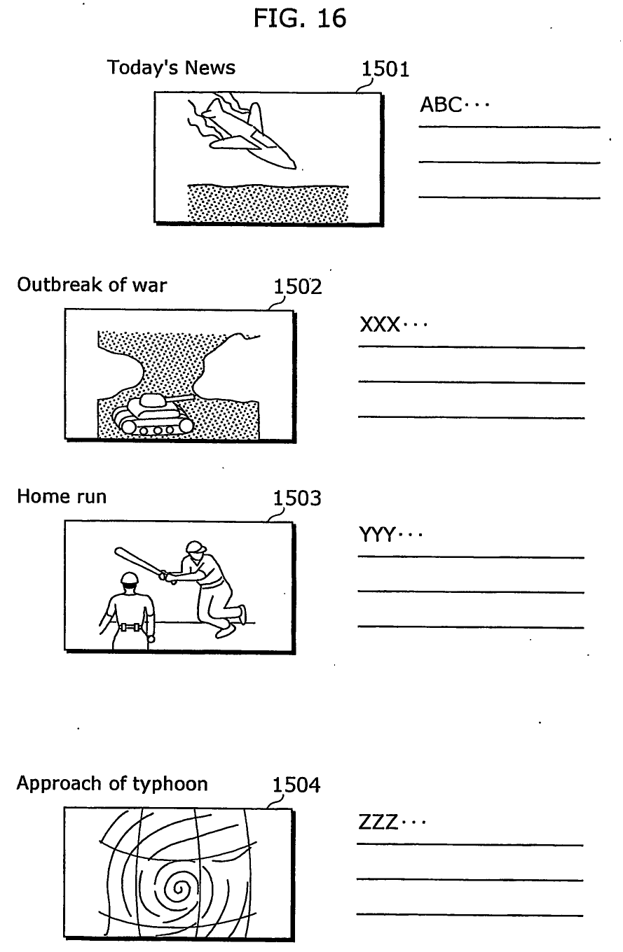

FIG. 16 shows a concrete example of the case in which the print information is updated by inserting the image information into the print information as described above, and printing is executed based on the updated print information.

Note that, in the present embodiment, it is described that the user selects positions for inserting scenes at the time of selecting the scenes from the video. The user may determine the positions at the time of sending a print instruction, not at the time of selecting the scenes. In such case, the image position determining unit 710 exchanges information with the print information converting unit 708, instead of the image storing unit 706.

### Third Embodiment

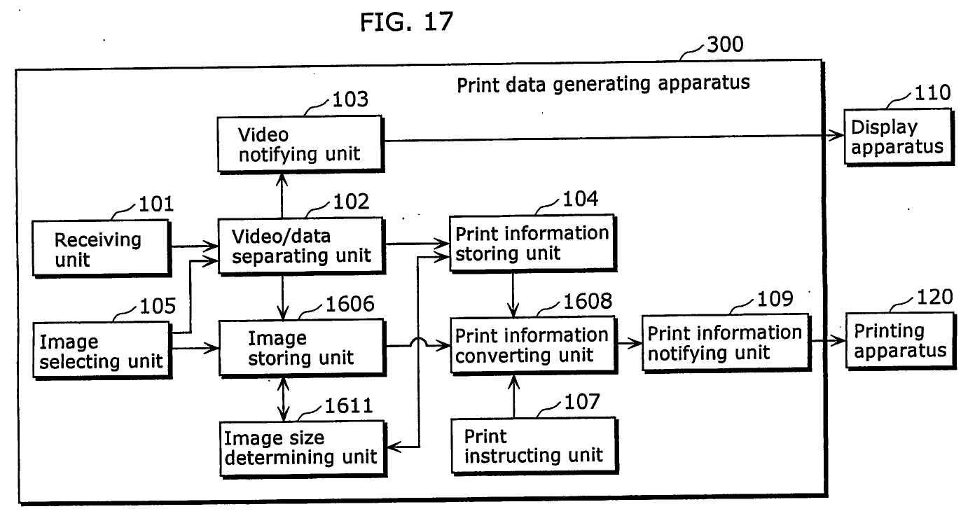

FIG. 17 is a block diagram showing the functional structure of the print data generating apparatus according to the present embodiment. The print data generating apparatus 300 according to the present embodiment differs from the print data generating apparatus 100 according to the first embodiment in that an image size determining unit 1611 is added. In addition, the processing executed by the image storing unit 1606 and the print information converting unit 1608 in the present print data generating apparatus 300 is different from that executed by the image storing unit 106 and the print information converting unit 108 in the print data generating apparatus 100. Note that the same numerical references are put for the same components as included in the print data generating apparatus 100. The description for the same components is therefore omitted.

The image size determining unit 1611 has a function to read out the information, which is described in the print information and indicates a size of the image to be inserted, and to allow the user to specify the size. The image size determining unit 1611 further notifies the image storing unit 1606 of the image size specified by the user.

The following description focuses on the difference between the present embodiment and the first embodiment.

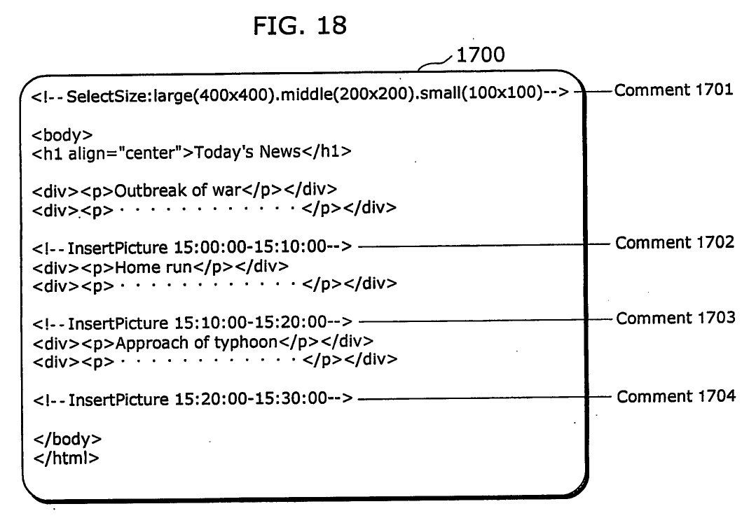

FIG. 18 shows an example of the print information according to the present embodiment. The print information 1700 according to the present embodiment shall be formatted in XHTML-Print. The trimming information such as CSS and the header information are as same as those described in the first embodiment. The description of such information is therefore omitted.

As is the case of the print information 200, the comments for inserting image information are described also in the print information 1700, however, the difference is that in the present print information 1700, the comment 1701 which starts with “SelectSize” is described. The “SelectSize” will be mentioned in detail later.

The present embodiment differs from the first embodiment in that the user can specify, at the time of selecting the scene, the size of a selected scene to be inserted. While watching a TV program the user notifies, using a remote controller, the image selecting unit 105 of the scene that he or she desires to insert into an object to be printed, or the like. The image selecting unit 105, having received the instruction for selecting a scene, notifies the image storing unit 1606 of the time when the selected scene is taken.

Having received the instruction from the image selecting unit 105, the image storing unit 1606 receives, from the video/data separating unit 102, the scene taken at the notified time, and converts it into a JPEG file, and also, inquires the image size determining unit 1611 of the size of the image to be inserted.

The image size determining unit 1611, having received the inquiry from the image storing unit 1606, reads the print information stored in the print information storing unit 104, and searches for the comment that includes a character string “SelectSize” described in the print information. The comment 1701 in the print information 1700 shown in FIG. 18 is taken as an example of it.

The image size determining unit 1611 reads that the character string that follows the character string “SelectSize” is large (250×400), middle (250×300), or small (150×200), and inquires the user of the size of the selected scene to be inserted.

Receiving the selection on size from among “large”, “middle” and “small” which are presented as options, the image size determining unit 1611 notifies the image storing unit 1606 of the size selected by the user. The image storing unit 1606 stores the JPEG file of the current image and the size-information notified by the image storing unit 1606 at the same time.

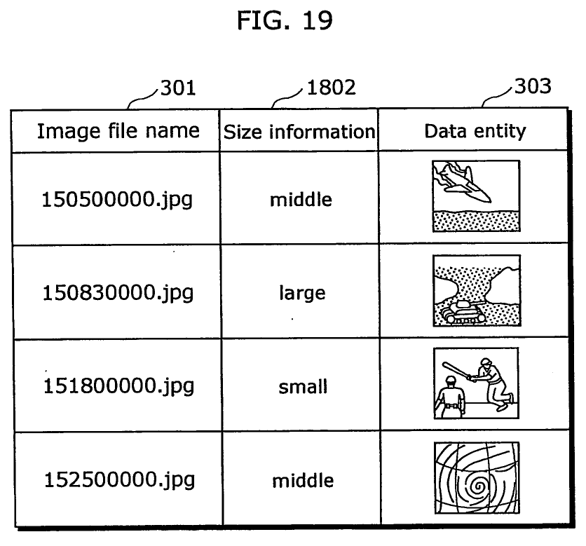

FIG. 19 shows an example of the image data which includes size information and is to be stored in the image storing unit 1606. As shown in FIG. 19, it is specified that the scenes selected respectively at the times “15:05:00” and “15:25:00” are inserted with the size “middle” and the scenes selected at the time “15:08:30” is inserted with the size “large”, while the scene selected at the time “15:18:00” is inserted with the size “small”.

When printing is instructed by the user after the insertion of the selected scenes, the print instructing unit 107 notifies the print information converting unit 1608 of the instruction.

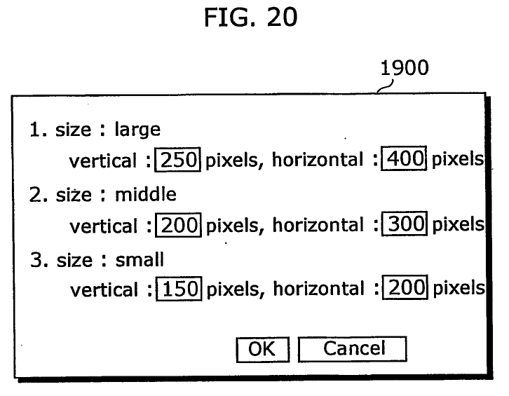

Note that FIG. 18 shows the example in which pixel values for each of the image sizes “large”, “middle” and “small” are already determined. The pixel values, however, may be changed by the user, as shown in FIG. 20.

The following describes, by showing an example, the difference between the print information converting unit 1608 according to the present embodiment and the print information converting unit 108 according to the first embodiment.

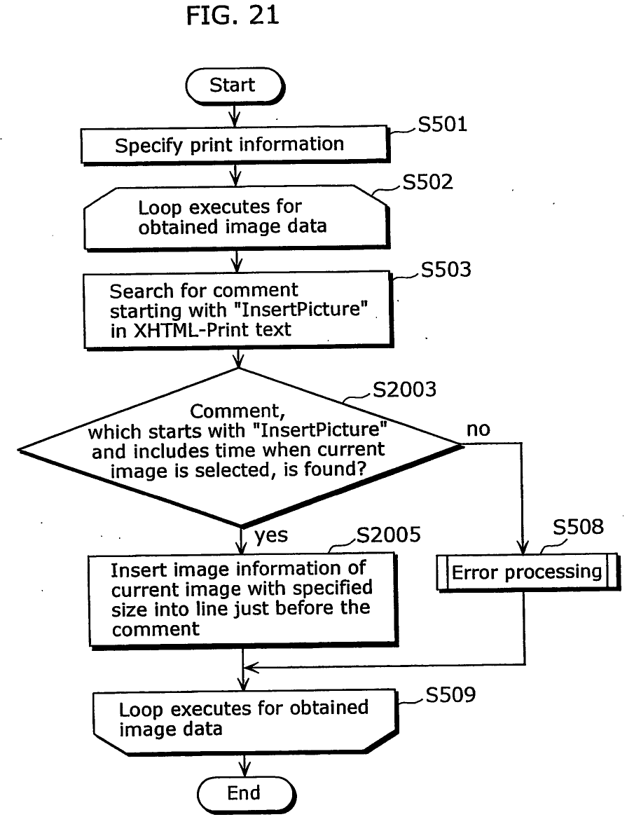

FIG. 21 is a flowchart showing the flow of the “image inserting processing” according to the present embodiment. The difference between the present flowchart and the one shown in FIG. 5 in the first embodiment is that Steps S2003 to S2005 are inserted instead of the Steps S504 to S507 in FIG. 5.

The print information converting unit 1608 searches, in the print information 1700, for a comment which starts with “InsertPicture” and includes the time at which the current image is selected. The print information converting unit 1608 further judges whether or not such comment is found. In the case such comment is found (S2003: yes), the print information converting unit 1608 inserts, in the line located just before the comment, the image information of the current image with the size specified by the user. In the case where such comment is not found (S2003: no), the error processing is executed (S508).

In this way, the present embodiment differs from the first embodiment in that the user can specify the size of an image at the time when inserting the image.

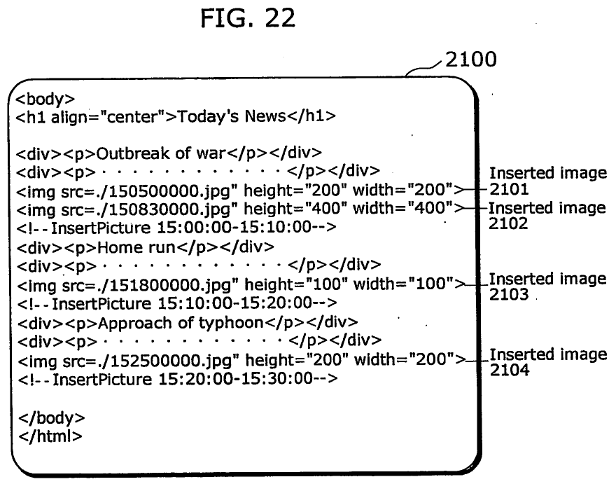

FIG. 22 shows an example of the print information 2100 in the case of inserting, into the print information 1700 shown in FIG. 18, the images with the sizes as indicated in FIG. 19. The difference between the present embodiment and the first embodiment is that attributes such as “height” and “width” are added to the inserted images 2101 to 2104 according to the size information described in the comment 1701 shown in FIG. 18.

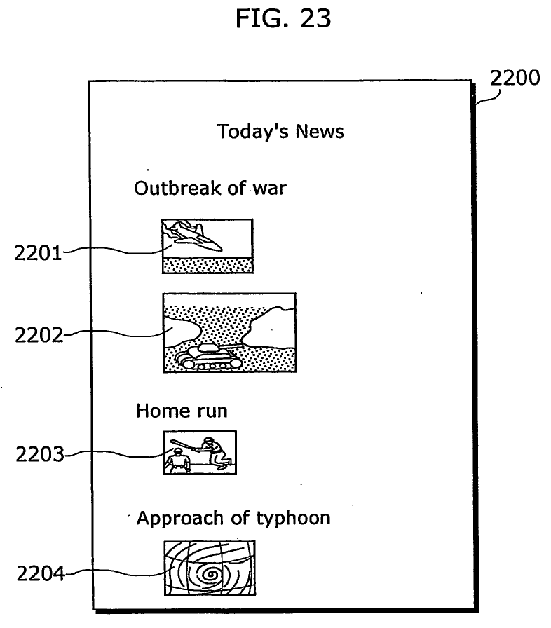

FIG. 23 shows a concrete example of executing printing based on the print information 2100 which is updated as described above.

Note that, in the present embodiment, the size of each image is specified by the user who selects the size from among the options presented, however, the user may input an exact size (e.g., the number of dots, cm or inc). In such case, the print information converting unit 1108 inserts each image in accordance with the size specified by the user.

Note also that, in the example shown in the present embodiment, the user is allowed to select an image size at the time of selecting a scene from a video. The user may, however, determine the image size at the time of sending a print instruction, but not at the time of selecting a scene. In such case, the print size determining unit 1611 exchanges information with the print information conversion unit 1608 instead of the image storing unit 1606.

### Fourth Embodiment

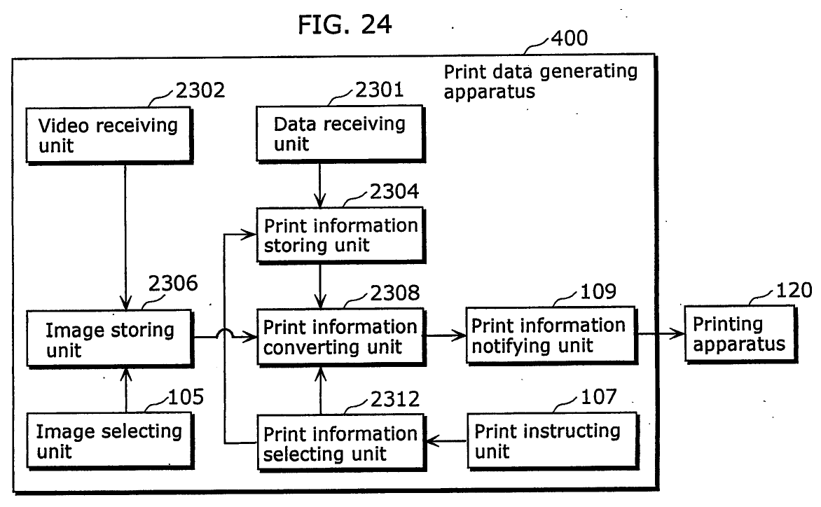

FIG. 24 is a block diagram showing the functional structure of the print data generating apparatus 400 according to the present embodiment. Compared to the print data generating apparatus 100 according to the first embodiment, the present print data generating apparatus 400 differs from the print data generating apparatus 100 in that the receiving unit 101 is replaced by two components of a video receiving unit 2302 and a data receiving unit 2301, and that a print information selecting unit 2312 is added. Also, an image storing unit 2306, a print information converting unit 2308 and a print information storing unit 2304 perform processing different from those included in the print data generating apparatus 100. Note that the same numeric references are put for other components in the print data generating apparatus 400 since they are as same as those in the print data generating apparatus 100. The description for the same components is therefore omitted.

The following focuses on the difference between the present embodiment and the first embodiment.

The present embodiment differs from the first embodiment in that the following points are taken into consideration: a video program and print information (i.e. a data program) are not necessarily transmitted at the same time; and that the program and the information are not necessarily transmitted using the same method.

In the print data generating apparatus 400, the data receiving unit 2301 receives the print information in data broadcasting included in digital broadcasting, and stores it into the print information storing unit 2304. The print information received by the data receiving unit 2301 does not, by all means, need to be transmitted via digital broadcasting. The print information may be obtained by receiving it via a communication network such as the Internet or the like, or by reading the data stored in a storage medium such as an SD card.

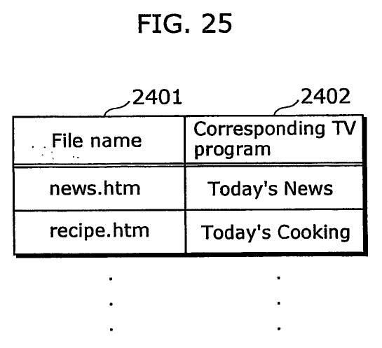

FIG. 25 shows an example of the print information to be stored in the print information storing unit 2304. A file name 2401 presents a file name of the stored print information while a corresponding program 2402 presents a name of the TV program whose images are to be inserted for the print information.

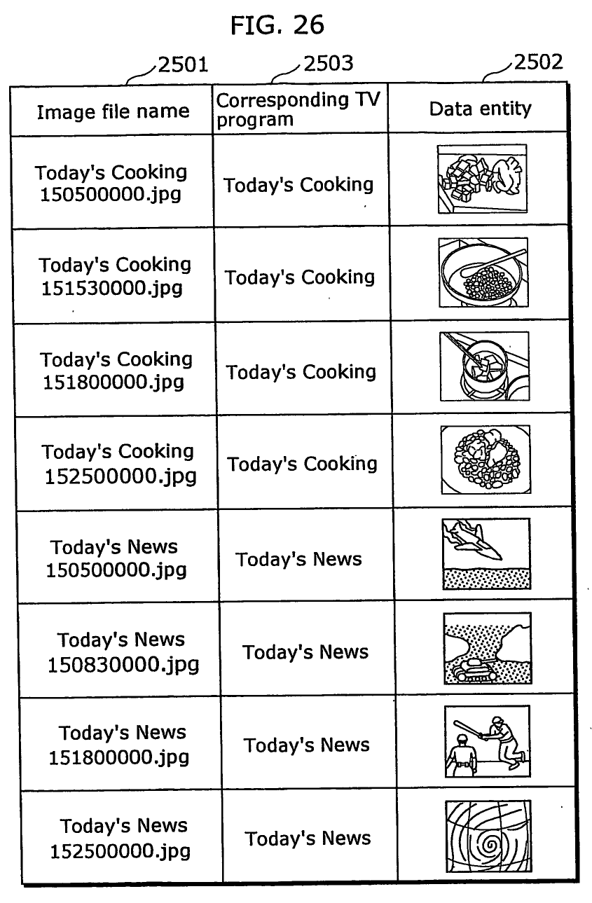

FIG. 26 shows an example of the image information to be stored in the image storing unit 2306. The method of storing images into the image storing unit 2306 is as same as the one used in the first embodiment. In the present embodiment, not only the time information but also the name of the corresponding program is added as an image file name 2501 so as to avoid overlapping of image file names. Note that a relative time used for the program may be specified as the time information. The name of the program from which the current image is taken is described in the program name 2503. The data entity 2502 is as same as the one described in the first embodiment.

When receiving a print instruction from the user in the state in which the print information and the image data shown in FIGS. 25 and 26 are respectively stored in the print information storing unit 2304 and the image storing unit 2306, the print instructing unit 107 firstly notifies the print information selecting unit 2312 that the print instruction is received. The print information selecting unit 2312, having received the notification, obtains the print information that is presently stored in the print information storing unit 2304. As shown in FIG. 25, two kinds of print information are stored: “Today's News”; and “Today's Cooking”. The print information selecting unit 2312, having obtained the print information from the print information storing unit 2304, presents options for print information to the user, and inquires the user of the print information to be printed. The inquiry may be made by displaying the titles of the corresponding TV programs on the screen or displaying a preview screen of the corresponding TV program. The inquiry method will not be mentioned here because it does not particularly relate to the present invention.

The print information selecting unit 2312, having received the user's instruction on print information to be printed, notifies the print information converting unit 2308 of the print instruction for the print information selected by the user. Having received the print instruction, the print information converting unit 2308 obtains the specified print information from the print information storing unit 2304, and passes it to the print information notifying unit 109 after the execution of the “image inserting processing”. The “image inserting processing” here is as same as the one described in the first embodiment, except for the point that the images taken from the program to be printed are to be inserted.

As described above, by using the print data generating apparatus 400 of the present embodiment, it is possible to insert the image information of the images selected by the user and print based on the print information, even in the case where the print information and the video signals from the TV are inputted from different lines.

Note that the accumulation of the print information and image data of different programs into the print information storing unit 2304 and the image storing unit 2306 allows printing not only of the program that is presently being broadcasted but also of the program that is broadcast in the past. Note that in the case where the user stores the print information and image data of different programs, and selects print information, the print information and the video signals do not need to be inputted from different lines. They may be inputted from a single line as shown in the first embodiment, and then separated into print information and videos by the print data generating apparatus. In such case, the following methods are conceivable: obtaining information for specifying the program to be selected by the user from Service Information (SI) transmitted via digital broadcast waves; and extracting the time at which images and print information are stored as well as channels from a TV program listing. Such methods, however, are not directly related to the present invention, therefore, the description will be omitted.

Note that, in the present embodiment, the print information is firstly received and the scenes are selected later, however, it may be vice versa. Moreover, plural print information (i.e., print information for providing the user with plural patterns of printing) may be associated with a single TV program.

### Fifth Embodiment

The present embodiment differs from the first embodiment in that a maximum number of the scenes to be inserted into an object to be printed can be limited. Such control on the insertion of the scenes is performed by the print information converting unit 2608 (not shown in the diagram) that is newly set instead of the print information converting unit 108 of the first embodiment.

The following description focuses on the difference between the present embodiment and the first embodiment.

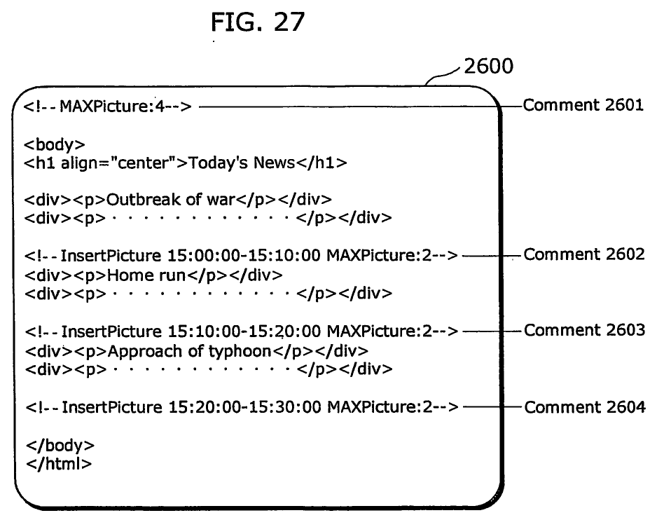

FIG. 27 shows an example of the print information to be transmitted in the present embodiment. In FIG. 27, “MAXPicture” (hereinafter to be referred to as “constant MAX0”) is described in the comment 2601. This indicates a total number of image information that can be inserted into each line located just before the comment. The user cannot insert the scenes exceeding the number “4” indicated in the description. “MAXPicture” (hereinafter to be referred to as “constant MAX[i]”) described in the comments 2602 to 2604 indicates a maximum number of image information that can be inserted into the respective comments. The user cannot insert the scenes surpassing the number “2” indicated in each comment.

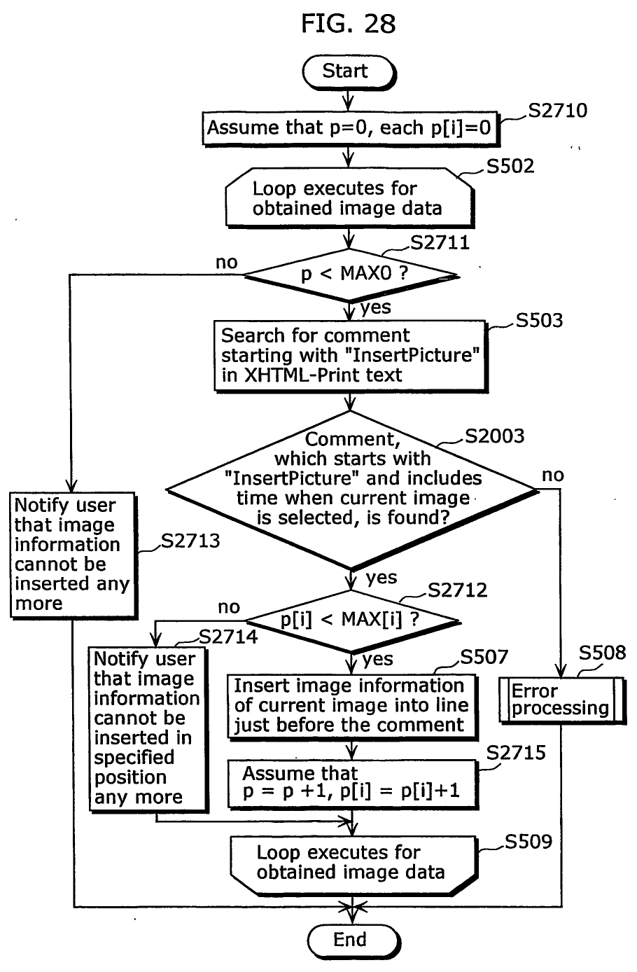

FIG. 28 is a flowchart showing the flow of the “image inserting processing” according to the present embodiment. The same numeric references are put for the same processing described in FIG. 5 in the first embodiment and FIG. 21 in the third embodiment. The following focuses on the processing different from those shown in FIGS. 5 and 21.

When the “image inserting processing” is started, “0” is substituted into a variable p and each variable p[i] (S2710). The variable p denotes a value indicating a total number of image information inserted into the print information. At the start of the processing, “0” is inputted as initial setting since not a single piece of image information is inserted at the beginning of the “image inserting processing”. The variable p[i] is a value indicating the number of image information that is inserted into the line located just before each comment. The number of the variables p[i] is determined according to the number of the comments for which a limitation is imposed on the number of image information to be inserted, out of all the comments within the print information, each indicating the position of the image information to be inserted. As is the case of the variable p, “0” is substituted as initial setting since not a single piece of image information is inserted into any of the comments when the “image inserting processing” is started.

Then, whether or not a variable p is smaller than a constant MAX0 is judged (S2711). Here, the constant MAX0 indicates the number of image information that can be inserted into the print information. In the case of the print information 2600 shown in FIG. 27, the number “4” indicated as a value of “MAXPicture” in the comment 2601 becomes a value of the constant MAX0. In the case where, the variable p is greater that or equal to the constant MAX0 (S2711: no), the user is notified that image information cannot be inserted any more (S2713) and the “image inserting processing” is terminated.

In the case where the variable p is less than the constant MAX0 (S2711: yes), whether or not the variable p[i] is less than the constant MAX[i] is examined after the execution of Steps S503 and S2003 (S2712).

Here, the constant MAX[i] is a value of “MAXPicture” described in each comment. In the case of each of the comments 2602 to 2604 described in the print information 2600 shown in FIG. 27, the constant MAX[i] indicates “2”.

In the case where the variable p[i] equals to the constant MAX[i] (S2712: no), the image information cannot be inserted in the position of the comment any more and the user is notified of it (S2714). After the notification, the processing proceeds to Step S509 and the same process is repeated for the next selected image. Note that if the processing does not end at Step S2714, this is because there might be a possibility to still insert image information accepted by another comment.

In the case where the variable p[i] is less than the constant MAX[i] (S2712: yes), image information is inserted into the line located just before the current comment (S507), and “1” is respectively added to the variable p and the variable p[i] corresponding to the comment (S2715). With the above processing, the print information that limits the number of image information can be generated.

It should be noted that, in the present embodiment, in the case where the number of images to be inserted exceeds the limit, it is not possible to insert any image thereafter; however, the user may select an image to be inserted. This can be realized by presenting to the user an option so that the user can select the image to be inserted besides that the user is notified that the insertion is not allowed in Steps S2713 and S2714. However, in the case of changing the processing of S2713 so as to realize this, the processing should proceed to S509 (loop processing for the next image, but not to “End”.

Note also that rather than to present to the user an option each time the number of image information is exceeded, it is possible not to set conditions for the judgments in Steps S2711 and S2712, terminate the processing for all the images to be inserted, and present to the user an option for inserting image information into the position at which the constant MAX0 and MAX[i] are exceeded after the variable p and variables p[i] are determined, so as to allow the user to select an image to be inserted.

As a method of presenting an option in the processing, only the images to be inserted can be presented to the user for selection, or a preview screen of the print information with all the image information inserted so far may be presented, so that the user can select the image to be inserted.

Note that the case in which a scene cannot be printed due to copyright protection may occur in the first through fifth embodiments. The signal presenting the print enable/disable information of the scene can be transferred to the print data generating apparatus in various ways: by superimposing the information; via the Internet; and via a medium like an SD card.

Having received the print enable/disable information, the print data generating apparatus can judge whether or not it is possible to print the scene selected by the user who watches a TV program. In the case where the scene cannot be printed, it is conceivable that the user is informed of it so that the scene is not stored in the image storing unit. Such method can prevent printing of the scene that is not allowed to be printed.

Note that the following methods are conceivable for transmitting the print enable/disable information: by notifying whether or not an image can be printed while the image is displayed; and by sending time information indicating the time range of a video or a TV program during which an image is allowed to be printed.

It should be noted that, from the first through fifth embodiments, when selecting an image from the video, the user can confirm whether or not to insert the image. In this case, the following methods are conceivable so that the user can confirm whether or not to insert an image: by displaying only the selected image; and by displaying a print preview screen in which the selected image is inserted. With the above methods, in the case where the user has selected an image by mistake, the image can be prevented from being inserted.

Note also that, from the first through fifth embodiments, when the user selected a scene, about each ten frames before and after the selected scene may be stored in the image storing unit so that the user can select an image to be inserted from among them.

This process can be realized by constantly storing the past ten frames of sequential images into a ring buffer and thus, at the moment when the user selects a scene, the previous ten frames of images and the following ten frames of images are stored into the image storing unit. With such method, it is possible for the user to print a scene he/she desires to print, not exactly at the moment the scene is displayed but at a different timing even for the case when the user sends a selecting instruction a little later.

The number of frames, as an option, may be determined by “previous n frames” and “following m frames”, instead of fixing the same number for both the previous and following frames. Basically, the user sends a selecting instruction after having seen a scene he/she desires to insert. In many cases, the user instructs for selecting a scene a little later than the time when the scene is displayed. Therefore, by setting a larger number for n than for m, the possibility for the user to choose a scene is widened. There is surely no need to always set a larger number for n than for m.

Note here that, from the first through fifth embodiments, the print data generating apparatus may obtain metadata with respect to the video so as to determine, based on the metadata, the scenes to be inserted into an object to be printed, instead that the user selects a scene to be inserted.

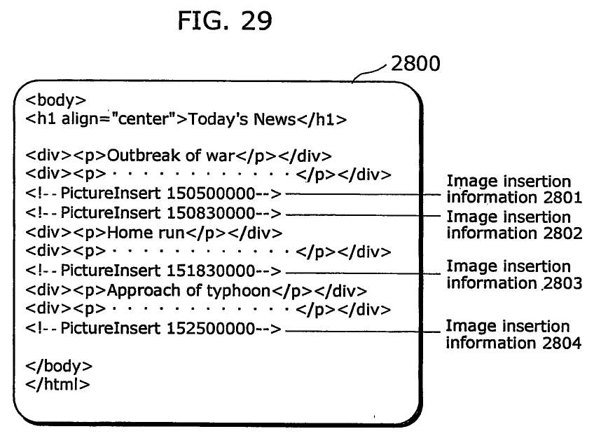

FIG. 29 shows an example of the print information that includes information on the insertion of images, according to the present embodiment. The image insertion information 2801 to 2804 respectively indicates each metadata for inserting an image. The image insertion information 2801 indicates that a scene selected at the time “15:05:00” is to be inserted into this position while the image insertion information 2804 presents that a scene selected at the time “15:25:00” is to be inserted into this position.

The image storing unit 106 receives the print information from the print information storing unit 104, and stores a scene for which the time is indicated in the image insertion information, at the indicated time. The format for storing a scene is as same as that used in the first embodiment described above.

Surely, the metadata may be transmitted by superimposing it on a video signal, distributed via the Internet, or an SD card, instead of being inserted into print information.

It should be noted that not only the image insertion information but also an attribute of the scene (e.g., information indicating a name of a main actor, a genre of the movie, or the like) may be attached to the metadata. By thus doing, it is possible to select a scene only in the case where preference information that is already registered by the user and the attribute information correspond to each other, and insert it into an object to be printed. The selected images may be inserted according to the order in which the user has selected the images, regardless of the attribute information and the preference information as described above.

It should be also noted that there surely is no need to insert an image even in the case of receiving the image insertion Information attached to the metadata. For example, the user may confirm whether to insert an image or not for each image corresponding to each image insertion information. In the case where an attribute of the scene is attached to the metadata, the user may confirm whether or not to insert an image only for the scene that corresponds to the attribute information already registered by the user.

It should be noted that, in the first through fifth embodiments above, it is described that the format of the print information is XHTML-Print, however, the format of the print information according to the present invention is not limited to this. The print information may be described in an XML language.

In the first through fifth embodiments, the print data generating apparatus, the printing apparatus and the display apparatus are presented as independent devices, however the present invention may be a device in which the print data generating apparatus and the printing apparatus or all of the three are built in.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The print data generating apparatus and the print data generation method according to the present invention is suitable for a digital broadcasting Set Top Box (STB) or a digital broadcast receiver equipped with a printing function.

1-19. (canceled)

20. A print data generating apparatus that generates print data based on a content included in digital broadcasting, comprising:
a broadcast wave receiving unit operable to receive digital broadcast waves, and to separate a video stream from the digital broadcast waves;
an image specifying unit operable to specify, according to a selecting instruction from a user, an image in a video displayed based on the separated video stream;
a print information obtaining unit operable to obtain print information described in a format that allows an insertion of an image into an object to be printed;
an insertion place specifying unit operable to specify a place in the obtained print information for inserting information representing the specified image; and
a print information converting unit operable to insert the information representing the specified image into the specified place, and to generate print data, while imposing a limitation on at least one of: a time when the selecting instruction is received; and a number of selected images selected according to the selecting instruction.

21. The print data generating apparatus according to claim 20,
wherein said print information converting unit is operable to insert the information representing the specified image, only in the case where the user's selecting instruction is received within a time period during which the insertion of an image is permitted, the time period being described in the print information.

22. The print data generating apparatus according to claim 20,
wherein a format of the print information is XHTML-Print.

23. The print data generating apparatus according to claim 20, further comprising,
an image position receiving unit operable to receive a user's instruction on position for inserting an image into an object to be printed,
wherein the information representing the specified image includes information indicating the position for inserting an image, the position being determined based on the user's instruction received by said image position receiving unit, and
said print information converting unit is further operable to generate print data so that the specified image is printed on the position indicated in the information indicating the position.

24. The print data generating apparatus according to claim 23, further comprising
an image size receiving unit operable to receive a user's instruction on size of the image to be inserted into an object to be printed,
wherein the information representing the specified image further includes information indicating the size of the image to be inserted, the size being determined by said image size receiving unit, and
said print information converting unit is further operable to generate print data so that the specified image is printed with the size indicated in the information indicating the size.

25. The print data generating apparatus according to claim 20,
wherein the print information includes an identifier that identifies the video, and
said print information converting unit is further operable to insert, into the specified place, information representing an image in the video identified by the identifier, and to generate print data.

26. The print data generating apparatus according to claim 25 further comprising:
a print information storing unit operable to store the obtained print information and the identifier; and
a video storing unit operable to store information representing the identified video,
wherein said insertion place specifying unit is operable (i) to read out the print information and the identifier from said print information storing unit, as well as the information representing the image in the video identified by the identifier, from said video storing unit, and (ii) to generate the print data based on the read-out print information and information representing the image.

27. The print data generating apparatus according to claim 26,
wherein said video specifying unit is further operable (i) to constantly store, in said video storing unit, a predetermined number of images displayed in a past; and in the case where the user selects an image, (ii) to present as options, predetermined numbers of images just before and after the selected image, respectively, and (iii) to specify the image from among images including the presented images.

28. The print data generating apparatus according to claim 27,
wherein the print information further includes attribute information associated with an image, and
said print information converting unit is further operable to hold user's preference information, and is operable (i) to insert the image in the case where the attribute information associated with the image corresponds to the user's preference information, and (ii) not to insert the image but to generate print data, in the case where the attribute information does not correspond to the user's preference information.

29. The print data generating apparatus according to claim 20,
wherein said broadcast wave receiving unit is operable to receive the digital broadcast waves via terrestrial waves or micro waves, and
said print information obtaining unit is operable to obtain the print information via a communication line.

30. The print data generating apparatus according to claim 25,
wherein the identifier is a name of a broadcast program which is associated with the print information, and
said print information obtaining unit is operable (i) to present, as an option for the print information which the user may select, information that includes the name of a broadcast program, and (ii) to obtain the print information based on a user's selection made in response to the presentation.

31. The print data generating apparatus according to claim 30, wherein said insertion place specifying unit is operable (i) to present, as an option, a preview screen of what is going to be eventually printed, and (ii) to specify the place based on the user's selection made in response to the presentation.

32. The print data generating apparatus according to claim 20,
wherein the print information includes information indicating a limitation on number of images that can be inserted into an object to be printed, and
said print information converting unit is operable to insert images into an object to be printed within a range of the number of images that can be inserted into the object to be printed, and to generate print data.

33. The print data generating apparatus according to claim 20,
wherein at least one of the received video data and print information includes information indicating images which are allowed to be inserted into an object to be printed and images which are not, and
said image specifying unit is operable to prevent, according to the information, an image from being selected in the case where the image is not allowed to be inserted into an object to be printed.

34. The print data generating apparatus according to claim 33,
wherein the information, indicating images which are allowed to be inserted into an object to be printed and images which are not, is specified using information indicating a time period.

35. A print data generating method for generating print data based on a content included in digital broadcasting, comprising:
receiving digital broadcast waves and separating a video stream from the digital broadcast waves;
specifying, according to a selecting instruction from a user, an image in a video displayed based on the separated video stream;
obtaining print information described in a format that allows an insertion of an image into an object to be printed;
specifying, in the obtained print information, a place for inserting information representing the specified image; and
inserting the information representing the specified image into the specified place, and generating print data, while imposing a limitation on at least one of: a time when the selecting instruction is received; and a number of selected images selected according to the selecting instruction.

36. A program for a print data generating apparatus that generates print data based on a content included in digital broadcasting, the program causing a computer to execute:
receiving digital broadcast waves and separating a video stream from the digital broadcast waves;
specifying, according to a selecting instruction from a user, an image in a video displayed based on the separated video stream;
obtaining print information described in a format that allows an insertion of an image into an object to be printed;
specifying, in the obtained print information, a place for inserting information representing the specified image; and
inserting the information representing the specified image into the specified place, and generating print data, while imposing a limitation on at least one of: a time when the selecting instruction is received; and a number of selected images selected according to the selecting instruction.

37. A content generating apparatus that generates a content into which a video is inserted, comprising:
a video obtaining unit operable to obtain at least one video;
a video specifying unit operable to specify at least one video from among the obtained videos, according to a selecting instruction from a user;
a control information obtaining unit operable to obtain control information described in a predetermined format that allows an insertion of a video;
an insertion place specifying unit operable to specify, in the obtained control information, a place for inserting information representing the specified video; and
a control information converting unit operable to insert the information representing the specified video into the specified place, and to generate print data, while imposing a limitation on at least one of: a time when the selecting instruction is received; and a number of selected images selected according to the selecting instruction.
